(19) United States
(12) Patent Application Publication
(10) Pub. No.: US 2002/0033609 A1
(43) Pub. Date: Mar. 21, 2002

(54) Automotive trunk with secondary opening device

(76) Inventor: In-Sun Baik, Hwasung-City (KR)

Correspondence Address: CHRISTIE, PARKER & HALE, LLP, 350 WEST COLORADO BOULEVARD, SUITE 500, PASADENA, CA, 91105, US

(21) Appl. No.: 09/880,155

(22) Filed: Jun. 11, 2001

(30) Foreign Application Priority Data
Sep. 21, 2000 (KR) 2000-55436

(51) Int. Cl. E05B 3/00

(52) U.S. Cl. 292/336.3

(57) ABSTRACT

An automotive trunk with a secondary opening device adapted to release a locking device from inside the trunk to thereby prevent an unexpected accident, the secondary opening device comprising a handle formed at an inner side of the trunk lid, a lever hinged to the handle via a hinge connector and a cable coupled to the lever and a lock lever of the latch assembly to manipulate the lock lever by means of the lever.

### BACKGROUND OF THE INVENTION

1. Field of the Invention

The present invention relates to an automatic trunk with an auxiliary opening device, and more particularly to an automotive trunk with a secondary opening device adapted to release a locking device from inside the trunk to thereby prevent an unexpected accident.

2. Description of the Prior Art

In general, trunk formed at a rear portion of a vehicle is placed therein with a spare tire and forms a spacious area for loading private packages and the like. A locking device is equipped near at the driver seat for opening the trunk via a manipulating switch.

However, there is a problem in a trunk in that once the trunk is closed, it cannot be opened unless a latch assembly at the locking device inside a vehicle is manipulated or a key is used, such that if the trunk is closed with a child therein, the trunk cannot be opened from inside. It is therefore urgent to develop a safety device for preventing an unexpected accident involving a trunk that cannot be opened from inside the trunk.

### SUMMARY OF THE INVENTION

The present invention is disclosed to solve the aforementioned problems and it is an object of the present invention to provide an automotive trunk with a secondary opening device adapted to release locking of a trunk by manipulating a latch assembly at a locking device inside the trunk.

In accordance with the object of the present invention, there is provided an automotive trunk with a secondary opening device which is mounted inside a trunk lid for manipulating a latch assembly of a locking device for opening and closing the trunk lid covering the trunk to thereby release the locking device.

### BRIEF DESCRIPTION OF THE DRAWINGS

For fuller understanding of the nature and objects of the invention, reference should be made to the following detailed description taken in conjunction with the accompanying drawings in which:

FIG. 1 is a perspective view of a trunk formed with a secondary opening device according to the present invention; and

FIG. 2 is a schematic drawing of a secondary opening device according to the present invention.

### DETAILED DESCRIPTION OF THE INVENTION

Now, preferred embodiment of the present invention will be described in detail with reference to the accompanying drawings.

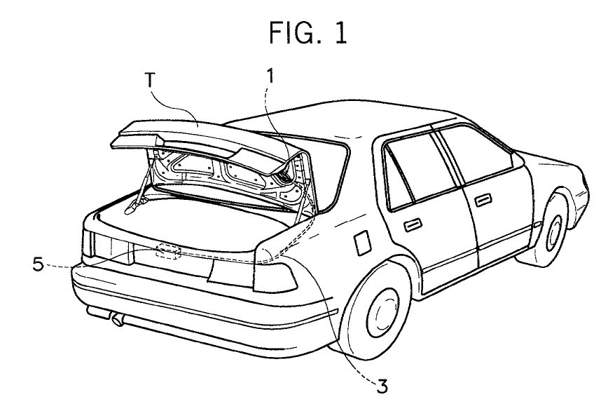

FIG. 1 is a perspective view of a trunk equipped with a secondary opening device according to the present invention, where the secondary opening device includes a handle 1 formed inside a trunk lid (T) connected to a latch assembly 5 via a cable 3 for manipulating the latch assembly 5 at a locking device for opening and closing the trunk lid (T) covering the trunk of a vehicle.

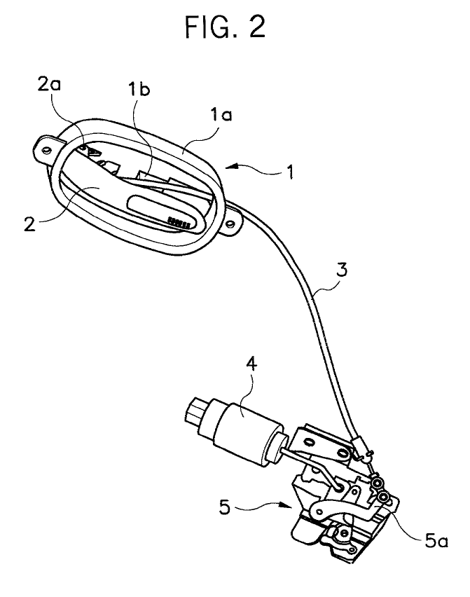

In other words, the secondary opening device according to the present invention includes, as illustrated in FIG. 2, the handle 1 mounted inside the trunk lid (T) and the cable 3 coupled to manipulate a lock lever 5a of the latch assembly 5 operated by an actuator 4 at the locking device connected to the handle 1, where the handle 1 is equipped with a lever 2 fixed to one end of the cable and hinged to a housing 1a via a hinge connector 2a for pulsing the cable 3 to manipulate the lock lever 5a at the latch assembly 5.

At this location, the housing 1a of the handle 1 is mounted therein with a guide 1b for holding the inserted cable 3 at an appropriate position. Meanwhile, it should be noted that the housing la of the handle 1 is coated by or attached with fluorescent material that illuminates at a slightest amount of light such that the handle 1 and the housing la can be easily located in a dark trunk.

Furthermore, the small electric bulb for shedding a little light to an area around the handle 1 is mounted, where the electric bulb is connected to a battery of a vehicle to form an electric circuit, such that even under a circumstance here a child is locked in a trunk and the trunk lid (T) is closed, the child can manipulate the lever 2 of the handle 1 in the trunk to release the latch assembly 5 at the locking device and to easily open the trunk lid (T).

It should be apparent that the handle 1 can be easily located by the fluorescent material illuminating at a slightest light and light from the electric bulb.

As apparent from the foregoing, there is an advantage in the automotive trunk with a secondary opening device thus described according to the present invention in that a latch assembly at a locking device in the trunk can be easily manipulated to release the locking, thereby preventing an unlooked-for accident.

What is claimed is:

1. An automotive trunk with a secondary opening device which is mounted inside a trunk lid for manipulating a latch assembly of a locking device for opening and closing the trunk lid covering the trunk to thereby release the locking device.

2. The trunk as defined in claim 1, wherein the secondary opening device comprises:
a handle formed at an inner side of the trunk lid;
a lever hinged to the handle via a hinge connector; and
a cable coupled to the lever and a lock lever of the latch assembly to manipulate the lock lever by means of the lever.

3. The trunk as defined in claim 1, wherein the handle is mounted with a housing coated by or attached with fluorescent material for illuminating at a amount of light.
